(19) United States
(12) Patent Application Publication
(10) Pub. No.: US 2015/0083862 A1
(43) Pub. Date: Mar. 26, 2015

(54) PRESSURIZED FUSELAGE OF AN AIRCRAFT, WITH A FUSELAGE STRUCTURE AND A PRESSURE BULKHEAD SPECIALLY MOUNTED THEREIN

(71) Applicant: Airbus Operations GmbH, Hamburg (DE)

(72) Inventors: Karim Grase, Hamburg (DE); M. Ichwan Zuardy, Hamburg (DE); Dieter Hachenberg, Hamburg (DE); Henning Scheel, Hamburg (DE); B. Claudio Vultaggio, Hamburg (DE)

(73) Assignee: Airbus Operations GmbH, Hamburg (DE)

(21) Appl. No.: 14/558,800

(22) Filed: Dec. 3, 2014

Related U.S. Application Data
(63) Continuation of application No. PCT/EP2013/061498, filed on Jun. 4, 2013.
(60) Provisional application No. 61/655,585, filed on Jun. 5, 2012.

(30) Foreign Application Priority Data
Jun. 5, 2012 (DE) 10 2012 011 027.8

(51) Int. Cl. B64C 1/10

(52) U.S. Cl. CPC B64C 1/10
USPC 244/121

(57) ABSTRACT

A pressurized fuselage of an aircraft includes a fuselage structure and a pressure bulkhead mounted therein for forming a fuselage-internal pressure region. The pressure bulkhead is attached on the edge region, by way of mounting means, to the inside of the fuselage structure. The mounting means comprise at least one pivoting socket arrangement, arranged on the edge side of the pressure bulkhead, which edge side faces away from the pressure region, and interacts with the fuselage structure, as well as a supporting frame element, arranged on the opposite edge side and supporting itself on the fuselage structure.

### CROSS-REFERENCE TO RELATED APPLICATIONS

This application is a continuation of International Application No. PCT/EP2013/061498, filed on Jun. 4, 2013, which claims priority from German Patent Application No. 10 2012 011 027.8 filed Jun. 5, 2012 and which claims the benefit of the filing date of United States Provisional Patent Application No. 61/655,585 filed Jun. 5, 2012, all of which are incorporated herein by reference.

### TECHNICAL FIELD

The invention relates to a pressurized fuselage of an aircraft, with a fuselage structure and a pressure bulkhead mounted therein for forming a fuselage-internal pressure region, which pressure bulkhead is attached on the edge region, by way of mounting means, to the inside of the fuselage structure.

### BACKGROUND OF THE INVENTION

In airplanes, in particular in commercial aircraft, it is necessary to maintain an air pressure in the cabin space, which air pressure corresponds to the normal pressure. This means that in such aircraft in flight there is a pressure differential between the interior pressure region and the exterior region as well as certain partitioned-off regions of the airplane. In order to maintain this pressure differential it is necessary to design the fuselage accordingly and to partition off in a pressure-proof manner, by means of pressure walls, any fuselage regions that are not required as cabin space.

In the case of passenger aircraft it is thus common practice to finish off the rear of the cabin space with a pressure bulkhead, also referred to as a “rear shell”. Despite a relatively modest overpressure of approximately 0.6 bar, in flight this pressure bulkhead is subjected to relatively large loads depending on the area. Consequently, in particular in wide-bodied aircraft, very large forces can occur on the pressure bulkhead. These forces are usually taken up by the fuselage structure of the aircraft.

From EP 0 217 117 A1 a pressurized fuselage of an aircraft is known, wherein in the rear region a pressure bulkhead is arranged so as to form a fuselage-internal pressure region. The pressure bulkhead has the shape of a spherical cap, from which a holding device follows on the negative-pressure side, which faces away from the cabin region. The holding device comprises a close-meshed net of interwoven belts, which net is attached to fuselage frames of the fuselage shell and has been tensioned so as to rest against the pressure bulkhead. The belts comprise plastic fibers that hold the pressure bulkhead at the rear by way of elastic spacers that are evenly distributed over the area of the pressure bulkhead. This holding device supports the pressure bulkhead as a safety device.

From DE 10 2006 029 231 A1 a rear pressure bulkhead to form a fuselage-internal pressure region is known, which pressure bulkhead in the unloaded state is almost flat, in other words is designed as a type of flat bulkhead. As a result of this, better use can be made of the cabin space. The flat pressure bulkhead has a circular or oval design and essentially comprises a bulkhead main section surrounded by a frame. The bulkhead main section is a net-like component comprising lattice-type webbing with a circumferential edge.

The frame carries this main bulkhead section and comprises a light-metal hollow profile. The web of the bulkhead main section is attached to the frame, which is riveted to the fuselage structure. A thermoplastic membrane rests in a sheet-like manner on the web of the bulkhead main section as a sealing element in order to achieve an airtight design of the planar pressure bulkhead.

The mounting means for installing the pressure bulkhead within the fuselage structure establish a mechanical connection between the circumferential edge of the pressure bulkhead and of the fuselage structure and thus also of the fuselage shell.

In particular, a pressure bulkhead designed in the manner of a flat bulkhead bulges outwards as a result of the overpressure in the cabin space vis-à-vis the exterior pressure.

### BRIEF SUMMARY OF THE INVENTION

An aspect of the invention for the mounting means to allow elastic deformation of the pressure bulkhead while at the same time creating a safe and secure mechanical connection between the pressure bulkhead and the fuselage structure.

The invention encompasses the technical teaching according to which the mounting means for affixing the pressure bulkhead to the fuselage structure comprise at least one ball-and-socket joint arrangement or tilting-sliding bearing arrangement, arranged on the edge side of the pressure bulkhead, which edge side faces away from the pressure region, and interacting with the fuselage structure, as well as a supporting frame element, arranged on the opposite edge side and supporting itself on the fuselage structure, for fixing the pivoting bearing arrangement.

The advantage of the solution according to an embodiment of the invention consists, in particular, of a very stable articulated connection between the preferably flat pressure bulkhead and the fuselage structure being created that can be constructed with justifiable technical expenditure. The pivoting bearing arrangement is able to absorb very high forces that occur as a result of the pressure differential between the cabin space and the exterior region of the aircraft during flight. In this arrangement any deformation of the pressure bulkhead, which deformation occurs as a result of this pressure differential, is also absorbed by the mounting means according to an embodiment of the invention. In this arrangement the supporting frame element placed opposite the pivoting bearing arrangement ensures that the pivoting bearing arrangement cannot move from its effective position, in particular when the exterior pressure is somewhat higher than the pressure within the cabin space.

According to a preferred embodiment of the invention, the pivoting bearing arrangement comprises a hemispherical pivoting head affixed to the edge side of the pressure bulkhead, which pivoting head interacts with a pivoting socket unit installed on the fuselage shell. In this arrangement the pivoting head can also be designed so as to be smaller than a hemisphere. Dimensioning of the sector portion and diameter of the pivoting head depends on the forces to be absorbed by the pivoting socket arrangement, and on the required movement range. A pivoting head can be affixed, preferably screwed, in a simpler manner to the edge of the pressure bulkhead. In contrast to this, the corresponding pivoting socket unit is immovably affixed to the fuselage structure.

In a preferred embodiment the pivoting socket unit is of a box-shaped design and comprises a pivoting surface having a pivoting socket depression, and an adjacent mounting surface that interacts with the fuselage structure. The pivoting surface is arranged relative to the adjacent mounting surface at an angle ranging from 70° to 90° in order to on the one hand ensure adequate mechanical stability of the box-shaped pivoting socket unit, and on the other hand to also permit elastic deformation of the pressure bulkhead. To this effect the box-shaped pivoting socket unit must be installed so that adequate spacing relative to the edge region of the pressure bulkhead is maintained.

According to another embodiment of the invention it is proposed that the pivoting socket depression of the pivoting socket unit and/or the pivoting head comprise a Teflon coating. This Teflon coating ensures low-friction functioning of the pivoting socket arrangement, and, furthermore, there is no need to provide lubricants such as grease or oil. Moreover, the acoustic characteristics of the pressure bulkhead, i.e. its acoustic decoupling, is supported.

The supporting frame element that holds the pivoting bearing arrangement in its effective position is preferably designed as a multiply-bent flat profile element which on a first end comprises a first mounting surface for attachment to the fuselage structure, and on the other end comprises a mounting surface for attachment to the pressure bulkhead. The supporting frame element can be made from a carbon-fiber-reinforced plastic (CRP) or preferably from titanium in order to ensure low mass but excellent radial rigidity while at the same time providing lateral flexibility. The supporting frame element can extend in a ring-shaped manner over the entire circumference of the pressure bulkhead in order to ensure air-tightness of the pressure bulkhead, or it can be arranged only over sector portions of the pressure bulkhead circumference with the use of corresponding sealing measures. Preferably, the supporting frame element is attached, by means of multi-row riveting, both to the fuselage structure and to the pressure bulkhead by way of the respective mounting surfaces. For a lenticular flat pressure bulkhead, riveting between the supporting frame element and the pressure bulkhead for implementing a “floating” bearing arrangement can be replaced by clearance-fit assemblies or connecting means comprising pins or bolts in elongated holes.

According to a preferred embodiment of the invention, it is proposed that several pivoting bearing arrangements as described above and respectively associated supporting frame elements, or a continuous ring-shaped supporting frame element interact. In this design the several pivoting bearing arrangements can be arranged so as to be equidistantly spaced apart along the circumference of the pressure bulkhead.

### BRIEF DESCRIPTION OF THE DRAWINGS

Further aspects of the invention are shown in more detail below with reference to the figures, together with a description of preferred exemplary embodiments of the invention. The following are shown:

FIG. 1 a partial cross-section of a pressurized fuselage of an aircraft in the region of a pressure bulkhead integrated at the rear of the aforesaid,

FIG. 2 a partial cross-section in the region of the mounting means for the pivoting attachment of the pressure bulkhead to the fuselage structure,

FIG. 3 a perspective view of the mounting means according to FIG. 3,

FIG. 4 a top view of the mounting means according to FIG. 3.

### DETAILED DESCRIPTION

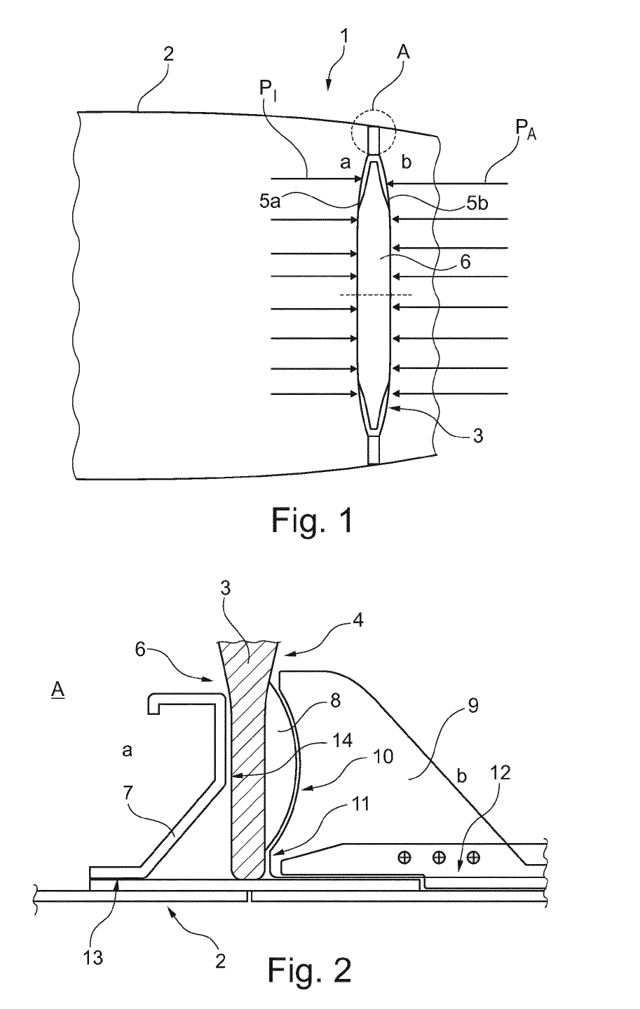

According to FIG. 1 the fuselage shell 2, which in the diagram is shown only in sections in the rear region 1, of the pressure bulkhead of a commercial aircraft comprises a pressure bulkhead 3 to form a fuselage-internal pressure region a. In the pressure region a there is cabin pressure, whereas in a pressure region b separated by the pressure bulkhead 3 there is ambient pressure. The cabin pressure acting on the pressure bulkhead 3 is indicated by a row of arrows p_{I}; the exterior pressure acting on the pressure bulkhead 3 on the opposite side is illustrated by a row of arrows P_{A}.

The pressure bulkhead 3 is designed in the manner of a flat bulkhead and to this extent comprises a planar cross-section. At the edge the pressure bulkhead 3 is pivotally attached in the interior to the fuselage structure 2 by way of attachment means arranged in the region A in order to absorb a pressure differential occurring as a result of the pressure differential between the fuselage-internal pressure region a and the external pressure region b and to absorb any deformation of the pressure bulkhead 3 as a result of the aforesaid.

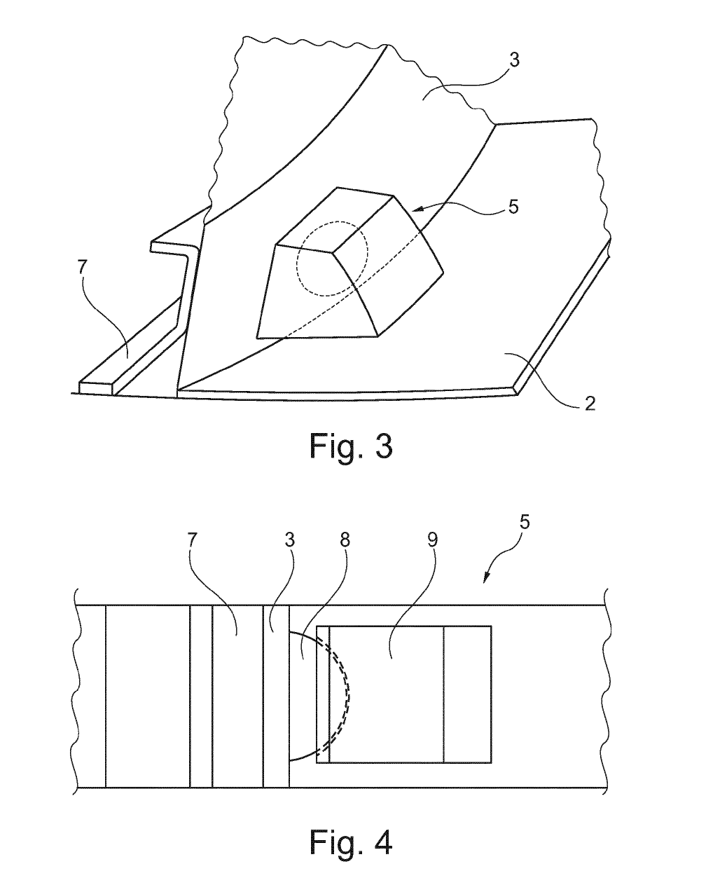

According to FIG. 2 the pivoting connection of the pressure bulkhead 3 to the fuselage structure 2 takes place, for example, by way of at least one pivoting socket arrangement 5 (FIG. 3), arranged on the edge side 4 of the pressure bulkhead 3, which edge side 4 faces away from the pressure region a, which pivoting socket arrangement 5 is immovably connected to the fuselage structure 2. On the opposite edge side 6 of the pressure bulkhead 3 a supporting frame element 7 is arranged that affixes the edge region of the pressure bulkhead 3 to the pivoting socket arrangement 5. The supporting frame element 7 extends between the fuselage structure 2 and the edge side 6 of the pressure bulkhead 3.

The pivoting socket arrangement 5 essentially comprises a hemispherical pivoting head 8 attached to the edge side 4 of the pressure bulkhead 3, which pivoting head 8 interacts with a pivoting socket unit 9 installed on the fuselage structure 2. The pivoting socket unit 9 comprises a pivoting socket depression 10 on a pivoting surface 11, wherein a mounting surface 12 that is adjacent to the aforesaid and that interacts with the fuselage structure 2 makes it possible to attach the pivoting socket unit 9 to the fuselage structure 2. Preferably, the pivoting socket depression 10 comprises a Teflon coating for minimizing joint friction.

The supporting frame element 7 is designed as a multiply-bent flat profile element. On one end the supporting frame element 7 comprises a first mounting surface 13 for attachment to the fuselage structure 2; on the other end a mounting surface 14 for attachment to the pressure bulkhead 3 is provided. Connection to the fuselage structure 2 or to the pressure bulkhead 3 takes place by way of both mounting surfaces 13 and 14 via multiple riveting, shown in the diagram by dashed lines.

It is also possible for several individual pivoting socket arrangements 5 to be arranged at predetermined spacing along the circumference of the pressure bulkhead 3 in order to establish a pivoting connection to the fuselage structure 2 (see FIG. 3). In contrast to this, the supporting frame element 7 placed opposite these several pivoting socket arrangements 5, shown as an example only in the diagram, is preferably designed so as to be circumferential in a ring-shaped manner.

According to FIG. 4 the pivoting socket unit 9 of the pivoting socket arrangement 5 is of a box-shaped design and interacts with the associated pivoting head 8 that is attached to the pressure bulkhead 3.

In addition, it should be pointed out that “comprising” does not exclude other elements or steps, and “a” or “one” does not exclude a plural number. Furthermore, it should be pointed out that characteristics or steps which have been described with reference to one of the above exemplary embodiments can also be used in combination with other characteristics or steps of other exemplary embodiments described above. Reference characters in the claims are not to be interpreted as limitations.

### LIST OF REFERENCE CHARACTERS

1 Rear region

2 Fuselage shell

3 Pressure bulkhead

4 Edge side

5 Pivoting socket arrangement

6 Edge side

7 Supporting frame element

8 Pivoting head

9 Pivoting socket unit

10 Pivoting socket depression

11 Pivoting surface

12 Mounting surface

13 Mounting surface

14 Mounting surface

a Pressure region, interior

b Pressure region, exterior

p_{I} Row of arrows, cabin pressure

p_{A} Row of arrows, external pressure

A Region of the pivoting connection

1. A pressurized fuselage of an aircraft, with a fuselage structure and a pressure bulkhead mounted therein for forming a fuselage-internal pressure region,
wherein the pressure bulkhead is attached on an edge region, by way of mounting means, to an inside of the fuselage structure,
wherein the mounting means comprise at least one pivoting socket arrangement, arranged on an edge side of the pressure bulkhead, the edge side facing away from the pressure region, and interacting with the fuselage structure; and
a supporting frame element arranged on an opposite edge side and supporting itself on the fuselage structure.

2. The pressurized fuselage of claim 1, wherein the pivoting socket arrangement comprises a hemispherical pivoting head affixed to the edge side of the pressure bulkhead, the pivoting head interacting with a pivoting socket unit installed on the fuselage structure.

3. The pressurized fuselage of claim 2, wherein the pivoting socket unit comprises a pivoting surface having a pivoting socket depression, and an adjacent mounting surface that interacts with the fuselage structure.

4. The pressurized fuselage of claim 3, wherein at least one of the pivoting socket depression and the pivoting head comprises a Teflon coating.

5. The pressurized fuselage of claim 3, wherein the pivoting surface is arranged at an angle a ranging from 70° to 90° relative to the mounting surface.

6. The pressurized fuselage of claim 1, wherein the supporting frame element is configured as a multiply-bent flat profile element comprising, on a first end, a first mounting surface for attachment to the fuselage structure, and, on a second end, a second mounting surface for attachment to the pressure bulkhead.

7. The pressurized fuselage of claim 6, wherein the supporting frame element is attached, by multi-row riveting, to the fuselage structure and/or to the pressure bulkhead.

8. The pressurized fuselage of claim 6, wherein the supporting frame element comprises a titanium material.

9. The pressurized fuselage of claim 2, wherein the pivoting socket unit and/or the supporting frame element are/is attached, to the pressure bulkhead by multi-row riveting.

10. The pressurized fuselage of claim 1, wherein the pressure bulkhead is configured as a flat bulkhead.

11. The pressurized fuselage of claim 1, further comprising a plurality of pivoting socket arrangements arranged along the circumference of the pressure bulkhead.
